(19) United States
(12) Patent Application Publication
(10) Pub. No.: US 2021/0020126 A1
(43) Pub. Date: Jan. 21, 2021

(54) DISPLAY PANEL AND DISPLAY DEVICE

(71) Applicant: HKC CORPORATION LIMITED, Shenzhen (CN)

(72) Inventor: Peixin LIN, Shenzhen (CN)

(21) Appl. No.: 17/039,444

(22) Filed: Sep. 30, 2020

Related U.S. Application Data
(63) Continuation of application No. PCT/CN2019/073352, filed on Jan. 28, 2019.

(30) Foreign Application Priority Data
Dec. 24, 2018 (CN) 201811586507.4

(51) Int. Cl. G09G 3/36

(52) U.S. Cl. CPC G09G 3/3607; G09G 3/3614; G09G 2330/021; G09G 2300/0439; G09G 2320/0626; G09G 2320/028; G09G 2320/0242; G09G 2330/045

(57) ABSTRACT

Disclosed is a display panel, the display panel includes pixels groups, each of the pixel groups includes a main pixel and a sub pixel, a driving brightness of the main pixel is larger than an original brightness of the main pixel, and a driving brightness of the sub pixel is smaller than an original brightness of the sub pixel, one data line is electrically connected with a main sub-pixel and a sub-sub-pixel with a same driving polarity located in two adjacent sub-pixel columns.

### CROSS-REFERENCE OF RELATED APPLICATIONS

The present application is a continuation application of International Patent Application with No. PCT/CN2019/073352, filed on Jan. 28, 2019, which claims the benefit of Chinese Patent Application with No. 201811586507.4, titled “display panel and display device”, filed in the National Intellectual Property Administration, PRC on Dec. 24, 2018, the entirety of which is hereby incorporated by reference.

### TECHNICAL FIELD

The present disclosure relates to the field of display technology, and more particularly relates to a display panel and a display device.

### BACKGROUND

In a display panel, the change of the brightness of each sub-pixel is controlled by the change of the driving signal on the data line to display a certain image. In order to display the correct image and avoid the phenomena of display panel polarization or common voltage shifting, the driving signal on the data line is a high frequency signal whose polarity changes rapidly with time. However, the high frequency driving signals will lead to a significant increase in power consumption of the circuit (including chips and circuits), thus increasing the driving power consumption required for the display panel, and at the same time, it is prone to cause potential safety hazards due to overheating of the circuit.

### SUMMARY

The main purpose of the application is to provide a display panel, aiming at solving the technical problem that the frequency of driving signals on the data lines is too high, reducing the driving power consumption of the display panel and avoiding potential safety hazards caused by overheating of the circuit.

In order to achieve the above objects, the present application provides a display panel including a plurality of pixel groups and a plurality of data lines, the pixel groups include a main pixel and a sub pixel, the main pixel includes a main sub-pixel, the sub pixel includes a sub-sub-pixel, the main sub-pixel and the sub-sub-pixel are arranged in a rectangular array, and the main sub-pixel and the sub-sub-pixel located in a same column form a sub-pixel column; the data lines extend in a longitudinal direction, the data lines being arranged in a transverse direction, and the data lines and the sub-pixel columns being arranged alternately in the transverse direction; a driving brightness of the main pixel is larger than an original brightness of the main pixel, and a driving brightness of the sub pixel is smaller than an original brightness of the sub pixel; one data line is electrically connected with a main sub-pixel and a sub-sub-pixel with a same driving polarity located in two adjacent sub-pixel columns, one main sub-pixel is electrically connected with only one of the data lines, and one sub-sub-pixel is electrically connected with only one of the data lines.

Optionally, a mixed gamma response of a main pixel and a sub pixel is equivalent to a preset gamma response.

Optionally, the main pixels and the sub pixels are arranged crosswise.

Optionally, the display panel further includes a plurality of scanning lines, the scanning lines extend in the transverse direction and arranged in the longitudinal direction; In the same main pixel, the main sub-pixels are longitudinally arranged and electrically connected with the same data line, and the main sub-pixels are electrically connected with different scanning lines respectively; in the same sub pixel, the sub-sub-pixels are longitudinally arranged and electrically connected with the same data line, and the sub-sub-pixels are electrically connected with different scanning lines respectively.

Optionally, a main sub-pixel and a sub-sub-pixel adjacent to the main sub-pixel are electrically connected to different data lines respectively.

Optionally, the display panel further includes a plurality of scanning lines, the scanning lines extend in the transverse direction and arranged in the longitudinal direction; in a same main pixel, the main sub-pixels are transversely arranged and electrically connected with a same scanning line, and the main sub-pixels are electrically connected with different data lines respectively; in a same sub-pixel, the sub-sub-pixels are transversely arranged and electrically connected with a same scanning line, and the sub-sub-pixels are electrically connected with different data lines respectively.

Optionally, in adjacent pixel groups, driving polarities of the main sub-pixels or the sub-sub-pixels at corresponding positions are opposite respectively.

Optionally, a driving polarity of a driving signal on a data line is periodically inverted.

In order to achieve the above object, the application also provides a display panel, which includes a plurality of pixel groups, a plurality of data lines and a plurality of scanning lines, the pixel groups include a main pixel and a sub pixel, the main pixel and the sub pixel are arranged crosswise, the main pixel includes a main sub-pixel, the sub pixel includes a sub-sub-pixel, the main pixel and the sub-pixel are arranged in a rectangular array, and the sub-pixel and the sub-pixel on a same column form a sub-pixel column, and the sub-pixel and the sub-pixel on a same row form a sub-pixel column. The data lines extend in the longitudinal direction, and the data lines are arranged in the transverse direction, and the data lines and the sub-pixel columns are arranged alternately in the transverse direction; the scanning lines extend in the transverse direction, and the scanning lines are arranged in the longitudinal direction, and the scanning lines and the sub-pixel rows are arranged alternately in the longitudinal direction; a driving brightness of the main pixel is larger than an original brightness of the main pixel, the driving brightness of the sub pixel is smaller than the original brightness of the sub pixel, and a mixed gamma response of the main pixel and the sub-pixel is equivalent to a preset gamma response; the data line is electrically connected with the main sub-pixel and the sub-sub-pixel with a same driving polarity in two adjacent sub-pixel columns, and one of the sub-pixels is electrically connected with only one of the data lines and one of the sub-pixels is electrically connected with only one of the data lines.

In order to achieve the above objects, the present application further proposes a display device including a display panel and a driving unit, the display panel includes a plurality of pixel groups and a plurality of data lines, the pixel groups include main pixels and sub pixels, the main pixels include main sub-pixels, the sub pixel includes a sub-sub-pixel, the main sub-pixel and the sub-sub-pixel are arranged in a rectangular array, and the main sub-pixel and the sub-sub-pixel located in a same column form a sub-pixel column; the data lines extend in a longitudinal direction, the data lines being arranged in a transverse direction, and the data lines and the sub-pixel columns being arranged alternately in the transverse direction; a driving brightness of the main pixel is larger than an original brightness of the main pixel, and a driving brightness of the sub pixel is smaller than an original brightness of the sub pixel; one data line is electrically connected with a main sub-pixel and a sub-sub-pixel with a same driving polarity located in two adjacent sub-pixel columns, one main sub-pixel is electrically connected with only one of the data lines, and one sub-sub-pixel is electrically connected with only one of the data lines; a driving unit is electrically connected with the data lines, the driving unit is configured to output a driving signal to the data lines, and the driving unit is also electrically connected to the scanning lines of the display panel.

In the technical scheme of the application, the display panel includes a plurality of pixel groups and a plurality of data lines, the pixel groups include a main pixel and a sub pixel, the main pixel includes a main sub-pixel, the sub pixel includes a sub-sub-pixel, the main sub-pixel and the sub-sub-pixel are arranged in a rectangular array, and the main sub-pixel and the sub-sub-pixel located in the same column form a sub-pixel column; The data lines extend in a longitudinal direction, the data lines being arranged in a transverse direction, and the data lines and the sub-pixel columns being arranged alternately in the transverse direction; a driving brightness of the main pixel is larger than an original brightness of the main pixel, and a driving brightness of the sub pixel is smaller than an original brightness of the sub pixel; one data line is electrically connected with a main sub-pixel and a sub-sub-pixel with the same driving polarity located in two adjacent sub-pixel columns, one main sub-pixel is electrically connected with only one of the data lines, and one sub-sub-pixel is electrically connected with only one of the data lines. During the operation of the display panel, the driving signal on the data line charges the main sub-pixel and the sub-sub-pixel to control the brightness of the main sub-pixel and the sub-sub-pixel. Among them, the driving brightness of the main pixel is greater than the original brightness of the main pixel and the driving brightness of the sub pixel is less than the original brightness of the sub pixel, so as to improve the color shifting condition under the large viewing angle of the display panel and increase the viewable angle of the display panel. At the same time, when the main sub-pixels and sub-sub-pixels with the same driving polarity in two adjacent sub-pixel columns are all connected to the same data line, the polarity of the driving signal on the data line can remain unchanged at least for the duration corresponding to one frame of the display screen. Compared with the case where the main pixels and sub-pixels with different driving polarities are connected to the same data line, the frequency of the required driving signal is greatly reduced, thus effectively reducing the driving power consumption of the display panel, reducing the heat generated by high frequency driving signals and avoiding potential safety hazards caused by overheating of the circuit.

### BRIEF DESCRIPTION OF THE ACCOMPANYING DRAWINGS

FIG. 1 is a structural diagram of an exemplary display panel;

FIG. 2 is a schematic diagram of a display panel of an example and a driving mode of an embodiment in accordance with the display panel of this disclosure;

FIG. 3 is a schematic structural diagram of an embodiment in accordance with the display panel of this disclosure;

FIG. 4 is a schematic diagram of a pixel group structure of an embodiment in accordance with the display panel of this disclosure;

FIG. 5 is a schematic diagram of transmittance-driving voltage at different viewing angles of an exemplary display panel;

FIG. 6 is a schematic diagram of normalized brightness at the partial viewing angle—normalized brightness at the positive viewing angle of an example display panel;

FIG. 7 is another schematic diagram of normalized brightness at the partial viewing angle—normalized brightness at the positive viewing angle of an example display panel;

FIG. 8 is a schematic diagram of gamma response of a display panel of an embodiment in accordance with the display panel of this disclosure;

FIG. 9 is another schematic structural diagram of an embodiment in accordance with the display panel of this disclosure;

FIG. 10 is a schematic diagram of the driving mode of the display panel in FIG. 9.

Various implementations, functional features, and advantages of this disclosure will now be described in further detail in connection with some illustrative embodiments and the accompanying drawings.

### DETAILED DESCRIPTION OF ILLUSTRATIVE EMBODIMENTS

Various technical solutions in the embodiments of this disclosure will now be described clearly and completely in the following in connection with drawings of illustrative embodiments. It is obvious that the described embodiments are a part of the embodiments of this disclosure, and not all of the embodiments. All other embodiments obtained by a person skilled in the art based on the embodiments of this disclosure without creative work fall into the scope of this disclosure.

It should be noted that all directional indicators (such as “up” “down” “left” “right” “front” or “rear”) as merely used to illustrate the relative positions and movements or the like of various components or parts under a specific posture (as depicted in the drawings), and if the specific posture change, these directional indicators will change accordingly.

In addition, the descriptions of “first”, “second” and the like in this application are used for descriptive purposes only and are not to be construed as indicating or implying a relative importance or implicitly indicating the number of technical features. Thus, features defined by “first” and “second” may include at least one of the features either explicitly or implicitly. In addition, the meaning of “and/or” appearing in the full text is to include three parallel schemes, taking “a and/or b” as an example, including scheme a or b, or schemes that both a and b satisfy at the same time. In addition, the technical solutions between the various embodiments may be combined with each other, but must be based on the realization of those skilled in the art, and when the combination of the technical solutions is contradictory or impossible to implement, it should be considered that the combination of the technical solutions does not exist. Nor is it within the scope of protection required by this application.

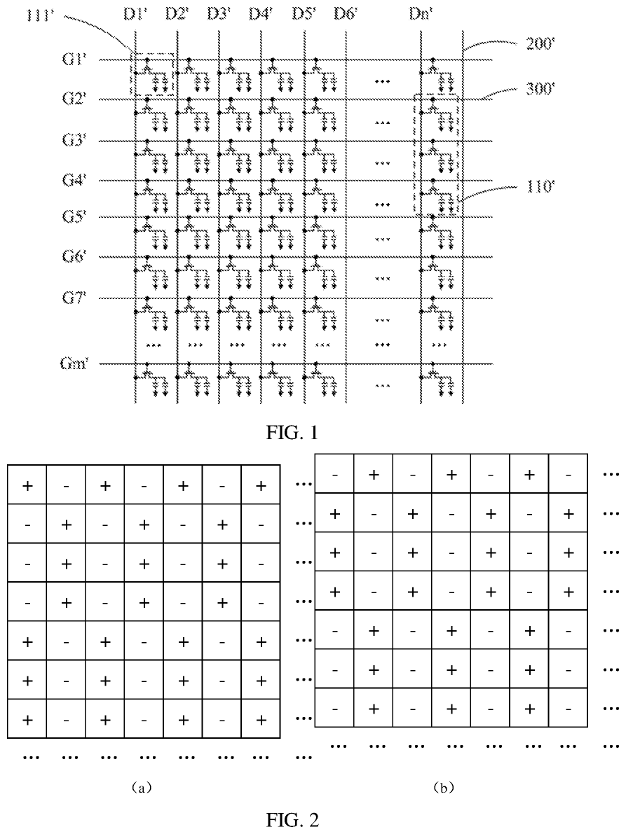

FIG. 1 is a structural diagram of an exemplary display panel, the display panel includes a plurality of pixels 110′, a plurality of data lines 200′ and a plurality of scan lines 300′. In which pixel 110′ includes sub-pixel 111′. In general, one pixel 110′ includes three kinds of main sub-pixels 111′, namely, red sub-pixel, green sub-pixel and blue sub-pixel, thus realizing the display of color images by the principle of spatial color mixing. Sub-pixels 111′ are arranged in a rectangular array, data lines 200′ and sub-pixel columns are arranged alternately, and sub-pixels on the same column are electrically connected with the same data line 200′, scanning lines 300′ and sub-pixel rows are arranged alternately, and sub-pixels on the same row are electrically connected with the same scanning line 300′. Under the action of the scanning signal Gm′ on the scanning line 300′, each row of main sub-pixels 111′ is turned on, and when the main sub-pixels 111′ are turned on, the main sub-pixels 111′ are charged under the driving action of the driving signal Dn′ on the data line 200′, thereby displaying a certain brightness. As shown in FIG. 2, there is a specific display panel driving method, in which FIG. 2(a) and FIG. 2(b) show the driving polarity applied to the sub-pixel 111′ by the driving signal Dn′ in two adjacent frame display panels, respectively, and the display panel is driven by dot inversion or the like. Then, the polarity of the drive signal Dn′ on the data line 200′ will change according to the rule of +−−−+++−−− . . . or −+++−−−+++ . . . within a frame of time, the drive signal on the data line will undergo multiple polarity reversals, and the frequency of the drive signal Dn′ is very high.

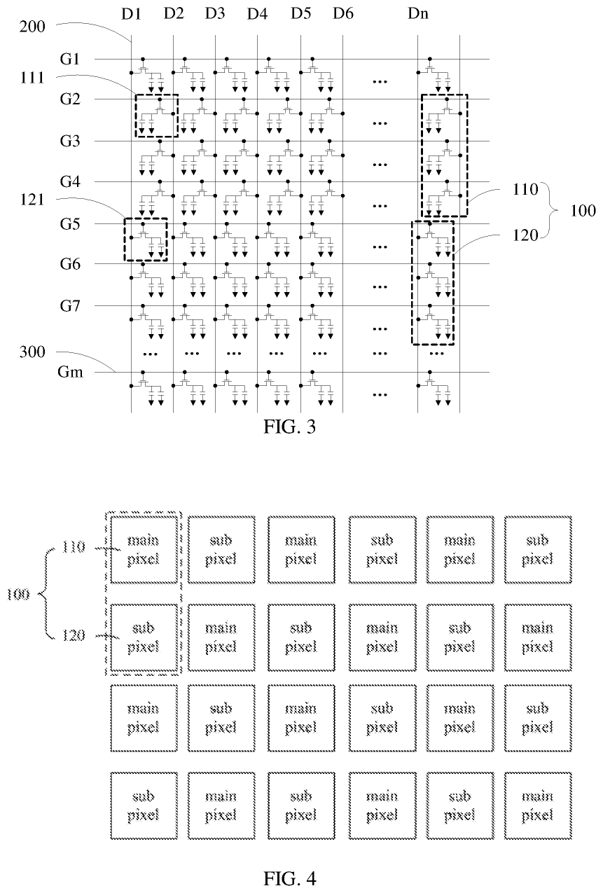

The present application provides a display panel. In an embodiment of the present application, as shown in FIGS. 3 and 4, the display panel includes a plurality of pixel groups 100 and a plurality of data lines 200, the pixel groups 100 include a main pixel 110 and a sub pixel 120, the main pixel 110 includes a sub-pixel 111, the sub pixel 120 includes a sub-sub-pixel 121, the main pixel 111 and the sub-sub-pixel 121 are arranged in a rectangular array, and the main pixel 111 and the sub-sub-pixel 121 located on the same column form a sub-pixel column; The data lines 200 extend in the longitudinal direction, and the data lines 200 are arranged in the transverse direction, and the data lines 200 and sub-pixel columns are arranged alternately in the transverse direction; The driving brightness of the main pixel 110 is larger than the original brightness of the main pixel 110, and the driving brightness of the sub pixel 120 is smaller than the original brightness of the sub pixel 120. A data line 200 is electrically connected to the main sub-pixel 111 and the sub-sub-pixel 121 with the same driving polarity in two adjacent sub-pixel columns, and a main sub-pixel 111 is electrically connected to only one data line 200 and a sub-sub-pixel 121 is electrically connected to only one data line 200.

In the following, the technical scheme of this application will be described in detail by taking the liquid crystal display panel as an example. The main sub-pixel or sub-sub-pixel includes a sub-pixel electrode and a switching device, the switching device includes a source electrode, a drain electrode and a gate electrode, the source electrode is electrically connected with a data line corresponding to the main sub-pixel or sub-sub-pixel, and the drain electrode is electrically connected with the sub-pixel electrode. The sub-pixel electrode is made of a transparent conductive material such as indium tin oxide (ITO). The data line charges the sub-pixel electrodes through the switching device, and then controls the liquid crystal deflection to display a certain brightness. Of course, the display panel may also include a common line and a plurality of storage capacitors, which are arranged one-to-one with sub-pixels to maintain the deflection direction of the liquid crystal to the next frame of image.

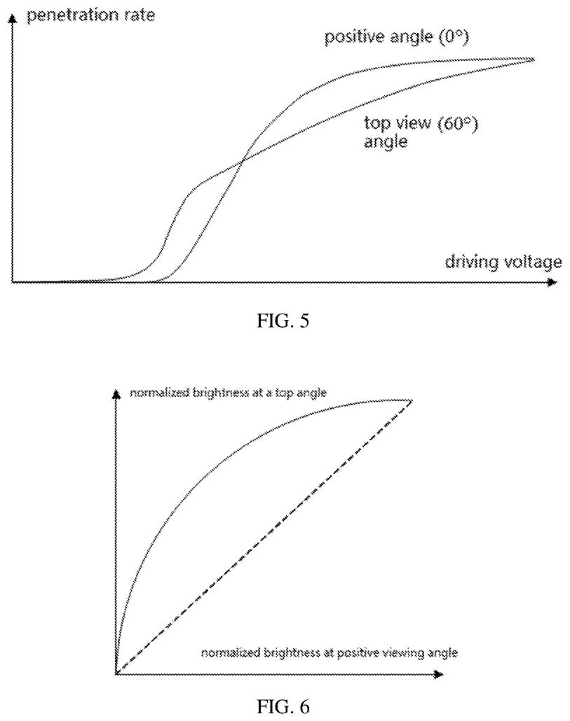

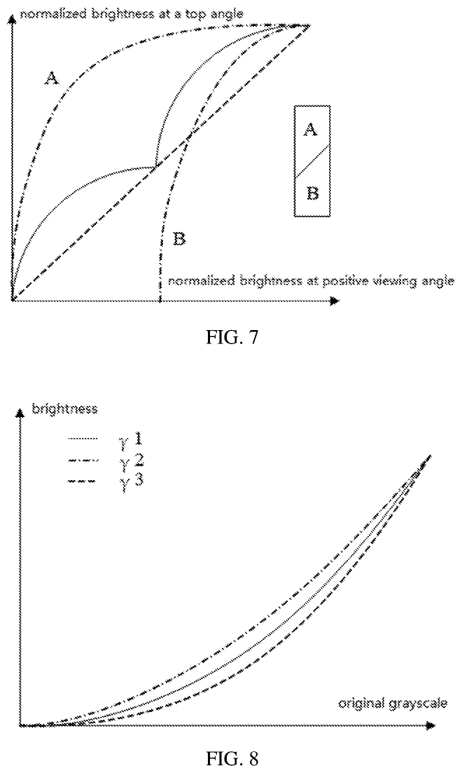

In the display panel, each pixel group 100 may include a plurality of main pixels 110 and sub pixels 120. In this embodiment, for simplicity, a description will be given with one pixel group 100 including one main pixel 110 and one sub pixel 120. Due to the limitation of liquid crystal deflection, as shown in FIG. 4, in one example, the transmittance—driving voltage curve of the display panel will drift relative to the transmittance—driving voltage curve in the case of the positive viewing angle, resulting in a decrease in the contrast of the picture, resulting in a color shift and a decrease in the viewable angle. As shown by the dashed lines in FIGS. 5 and 6, in an ideal case, the normalized brightness at the partial viewing angle is linearly related to the normalized brightness at the positive viewing angle, however, as shown by the solid lines in FIG. 6, in a practical case, the normalized brightness at the partial viewing angle is non-linearly related to the normalized brightness at the positive viewing angle, resulting in a smaller viewable angle of the display panel and a color shift. As shown in FIG. 7, in another example, in order to correct the phenomenon that the viewable angle of the display panel becomes smaller and the color is shifted, the pixel or sub-pixel is split into two parts a and b, and the part a and the part b are controlled to display different brightness, respectively. In FIG. 7, the two dash-dot lines correspond to the relationship between the normalized brightness of part a and part b under the partial viewing angle and the positive viewing angle, respectively, where the brightness actually displayed by part a is higher and the brightness actually displayed by part b is lower, while the effect of the final mixing of part a and part b is as shown by the solid line in FIG. 7, which is close to the ideal situation shown by the dashed line in FIG. 7, thus improving the viewing angle of the display panel and reducing the color shift. However, this method of partitioning the pixels or sub-pixels themselves will lead to a decrease in the transmittance of the pixels or sub-pixels in the display panel, resulting in a deterioration in the display quality of the display panel. However, in this embodiment, as shown in FIGS. 3 and 4, by dividing the pixels in the pixel group 100 into the main pixel 110 and the sub pixel 120, and controlling the driving brightness of the main pixel 110 to be greater than its original brightness and the driving brightness of the sub pixel 120 to be less than its original brightness, the relationship between the normalized brightness of part a and part b in the partial and positive viewing angles as shown in FIG. 7 is simulated. Among them, the original brightness refers to the display brightness directly determined according to the initial display picture, and the driving brightness is the brightness that is increased or decreased relative to the original brightness, thereby ensuring the transmittance of the main pixel 110 and the sub pixel 120 is constant. Under the premise, increase the viewing angle of the display panel, reduce the color shift, and improve the display effect of the display panel.

Among them, the main pixel 110 and the sub pixel 120 themselves may adopt the same or similar structure, i.e., the main pixel 110 includes the main sub-pixel 111 and the sub pixel 120 includes the sub-sub-pixel 121. Generally, the main pixel 110 includes three kinds of main pixels, namely, red main pixels, green main pixels and blue main pixels, and is arranged according to a certain rule. Similarly, sub pixel 120 includes three sub-pixels, namely, red sub-pixel, green sub-pixel and blue sub-pixel, and is arranged according to a certain rule to realize the display of color pictures. As a whole of the display panel, the main and sub-sub-pixels 111 and 121 are arranged in a rectangular array, and the main and sub-sub-pixels 111 and 121 on the same column form a sub-pixel column and are arranged alternately with the data line 200 extending in the longitudinal direction, so as to realize the electrical connection between the data line 200 and the main and sub-sub-pixels 111 and 121 and reduce the occurrence of cross-line. In order to reduce the polarity reversal frequency of the drive signal Dn on the data line 200, that is, to reduce the frequency of the drive signal Dn, the data line 200 is electrically connected to the main sub-pixel 111 and the sub-sub-pixel 121 with the same drive polarity in the adjacent two sub-pixel columns, while one main sub-pixel 111 is electrically connected to only one data line 200 and one sub-sub-pixel 121 is electrically connected to only one data line 200, so as to avoid confusion in driving caused by multiple data lines controlling the same sub-pixel. When the main sub-pixel 111, the sub-sub-pixel 121 and the data line 200 are connected in the above-mentioned manner, if the display panel is driven in the driving manner described in FIG. 2, the polarity of the driving signal Dn on the data line 200 will change according to the rule of ++++++++++ . . . , or −−−−−−−−−− . . . . That is to say, the polarity of the driving signal on the data line 200 does not change within the corresponding time period of one frame, thereby reducing the frequency of the driving signal, reducing the heat generated in the circuit, further reducing the display power consumption of the display panel, and avoiding potential safety hazards due to overheating of the circuit. Of course, at the time of frame conversion, the polarity of the drive signal Dn on the data line 200 can be reversed to avoid polarization of the display panel and offset of the common voltage.

In this embodiment, the display panel includes a plurality of pixel groups 100 and a plurality of data lines 200, the pixel groups 100 include a main pixel 110 and a sub pixel 120, the main pixel 110 includes a main sub-pixel 111, the sub pixel 120 includes a sub-sub-pixel 121, the main sub-pixel 111 and the sub-sub-pixel 121 are arranged in a rectangular array, and the main sub-pixel 111 and the sub-sub-pixel 121 located on the same column form a sub-pixel column; The data lines 200 extend in the longitudinal direction, and the data lines 200 are arranged in the transverse direction, and the data lines 200 and sub-pixel columns are arranged alternately in the transverse direction; the driving brightness of the main pixel 110 is larger than the original brightness of the main pixel 110, and the driving brightness of the sub pixel 120 is smaller than the original brightness of the sub pixel 120. A data line 200 is electrically connected to the main sub-pixel 111 and the sub-sub-pixel 121 with the same driving polarity in two adjacent sub-pixel columns, and a main sub-pixel 111 is electrically connected to only one data line 200 and a sub-sub-pixel 121 is electrically connected to only one data line 200. During the operation of the display panel, the driving signal on the data line 200 charges the main sub-pixel 111 and the sub-sub-pixel 121 to control the brightness of the main sub-pixel 111 and the sub-sub-pixel 121. Among them, the driving brightness of the main pixel 110 is greater than the original brightness of the main pixel 110, and the driving brightness of the sub pixel 120 is less than the original brightness of the sub pixel 120, so as to improve the color shift condition under the large viewing angle of the display panel and increase the viewable angle of the display panel. At the same time, when the main pixels 111 and sub-pixels 121 with the same driving polarity in two adjacent sub-pixel columns are all connected to the same data line, the polarity of the driving signal on the data line 200 can remain unchanged for at least one frame of the display screen. Compared with the case where the main pixels 111 and sub-pixels 121 with different driving polarities are connected to the same data line 200, the frequency of the required driving signal is greatly reduced, thereby effectively reducing the driving power consumption of the display panel, reducing the heat generated by high frequency driving signals and avoiding potential safety hazards caused by overheating of the circuit.

In the display panel, the driving polarity of the driving signal Dn on the data line is periodically inverted, and the inversion period can be an integer multiple of the period corresponding to the frame rate of the display panel to realize the inversion between frames, thereby avoiding polarization in the display panel, reducing the offset of the common voltage and improving the display effect of the display panel.

Further, a mixed gamma response of a main pixel 110 and a sub pixel 120 is equivalent to a preset gamma response.

In the display panel, the part a and the part b shown in FIG. 7 are simulated with the main pixel 110 and the sub pixel 120, respectively, to increase the viewable angle of the display panel and reduce the color shift. Specifically, the driving luminance of the main pixel 110 is larger than the original luminance of the main pixel 110, and the driving luminance of the sub pixel 120 is smaller than the original luminance of the sub pixel 120. Under the action of the drive signal Dn on the data line, the liquid crystals in the main sub-pixel 111 and the sub-sub-pixel 121 are deflected, resulting in a change in light transmittance, thus showing different brightness. However, due to the influence of the photoelectric characteristics of the liquid crystal, if the driving signal is determined directly from the initial picture signal, there will be a non-linear gamma response between the driving signal and the brightness of the final display. Therefore, in the driving process, it is necessary to perform inverse gamma correction on the initial picture signal to obtain the corrected driving signal to compensate for the non-linear characteristics of the display panel and realize distortion-free display. As shown in FIG. 8, when performing inverse gamma correction on the initial picture signal, the corrected gamma value in the inverse gamma correction process is determined according to the gamma value corresponding to the gamma response of the display panel, specifically, the relationship between the corrected gamma value and the gamma value is usually reciprocal. Gamma values reflect the characteristics of the display panel itself. The first gamma value γ1 corresponds to a normal display state, a typical first gamma value γ1 is 2.2 to 2.5, and a commonly used first gamma value γ1 is 2.2; the second gamma value γ2 corresponds to a display state in which the display is bright, and The second gamma value γ2 is smaller than the first gamma value γ1; the third gamma value γ3 corresponds to a display state in which the display is dark, and the third gamma value γ3 is at the first gamma value γ1. Therefore, by selecting an appropriate second gamma value γ2 and a third gamma value γ3. The mixed gamma response of the main pixel 110 and the sub pixel 120 is made equivalent to a preset gamma response, i.e., a gamma response corresponding to the first gamma value γ1, to improve the display effect.

As shown in FIGS. 3 and 4, the main pixel 110 and the sub pixel 120 are arranged crosswise, that is, the upper, lower, left and right adjacent pixels of the main pixel 110 are all sub pixels 120, and the upper, lower, left and right adjacent pixels of the sub pixel 120 are all main pixels 110. Of course, in other specific examples, the display panel may also be divided into different display areas according to the viewing angle, and pixel groups 100 including the main pixel 110 and the sub pixel 120 may be provided in the display areas corresponding to the off-viewing angle; In the display area corresponding to the positive viewing angle, each pixel is directly driven in the manner shown in the example.

In an embodiment of the present application, as shown in FIG. 3, the display panel further includes a plurality of scan lines 300 extending in the lateral direction and arranged in the longitudinal direction; In the same main pixel 110, the main sub-pixels 111 are longitudinally arranged and electrically connected to the same data line 200, and each main sub-pixel 111 is electrically connected to a different scanning line 300. In the same sub pixel 120, sub-pixels 121 are longitudinally arranged and electrically connected to the same data line 200, and each sub-sub-pixel 121 is electrically connected to a different scanning line 300. In this embodiment, each sub-pixel in each pixel is arranged in the longitudinal direction, and at least two scanning lines are required to realize scanning driving (three scanning lines are shown in the figure to drive three sub-pixels respectively) corresponding to each pixel, while each sub-pixel in the same pixel shares a data line. Since the cost of scanning lines in the display panel is often lower than the cost of data lines, this driving method can reduce the number of data lines required in the display panel, thereby reducing the cost of the display panel.

Further, adjacent main sub-pixels 111 and sub-sub-pixels 121 are electrically connected to different data lines 200, respectively. In the case shown in FIG. 3, since each main pixel 110 includes three main sub-pixels 111 and each sub pixel 120 includes three sub-pixels 121, the next sub-pixel is connected to the same data line every three corresponding sub-pixels in the same column, while the three sub-pixels in the interval are sickled to the other data line. By controlling the adjacent main sub-pixel 111 and sub-sub-pixel 121 to be electrically connected to different data lines 200, the display panel is driven by dot inversion in units of the main pixel 110 or the sub pixel 120, thereby helping to avoid polarization of the display panel, reduce offset of the common voltage, and improve the display effect of the display panel.

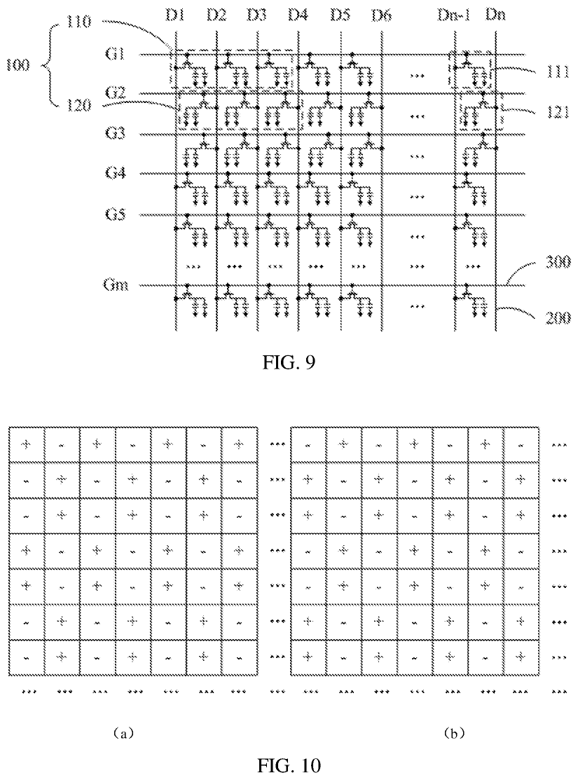

In another embodiment of the present application, as shown in FIG. 9, the display panel further includes a plurality of scan lines 300, which extend in the lateral direction and are arranged in the longitudinal direction; In the same main pixel 110, the main sub-pixels 111 are arranged laterally and electrically connected to the same scanning line 300, and each main sub-pixel 111 is electrically connected to a different data line 200. In the same sub pixel 120, sub-pixels 121 are arranged laterally and electrically connected to the same scanning line 300, and each sub-sub-pixel 121 is electrically connected to a different data line 200. In this embodiment, each sub-pixel in each pixel is arranged in the lateral direction, and at least two data lines are required to drive each pixel (three data lines are shown in the figure to drive three sub-pixels respectively), while each sub-pixel in the same pixel shares a scanning line. Since the sub-pixels correspond to the data lines one by one in one pixel, it is helpful to further reduce the frequency of the drive signal Dn on the data lines, thereby reducing circuit power consumption and thermal effect, while giving the sub-pixels sufficient charging time and improving the display effect of the display panel.

Further, as shown in FIG. 10, in adjacent pixel groups 100, the driving polarities of the main pixel 110 or the sub pixel 120 at each corresponding position are opposite. That is, in this embodiment, the display panel is driven by dot inversion in units of the pixel group 100 to avoid polarization of the display panel and reduce offset of the common voltage. In the two adjacent pixel groups 100, the driving polarities of the main sub-pixels and main sub-pixels with the same relative positions are opposite, while the driving polarities of the sub-sub-pixels and sub-sub-pixels with the same relative positions are opposite.

This application also proposes a display panel, as shown in FIGS. 3 and 9, which includes a plurality of pixel groups 100, a plurality of data lines 200 and a plurality of scanning lines 300, the pixel groups 100 include a main pixel 110 and a sub pixel 120, the main pixel 110 and the sub pixel 120 are arranged crosswise, the main pixel 110 includes a main sub-pixel 111, the sub pixel 120 includes a sub-sub-pixel 121, the main pixel 111 and the sub-sub-pixel 121 are arranged in a rectangular array, and the main pixel 111 and the sub-sub-pixel 121 on the same column form a sub-pixel column, and the sub-pixel 111 and sub-sub-pixel 121 on the same row form a sub-pixel row. The data lines 200 extend in the longitudinal direction, and the data lines 200 are arranged in the transverse direction, and the data lines 200 and sub-pixel columns are arranged alternately in the transverse direction; The scanning lines 300 extend in the lateral direction, and the scanning lines 300 are arranged in the longitudinal direction, and the scanning lines 300 and sub-pixel rows are arranged alternately in the longitudinal direction; the driving brightness of the main pixel 110 is larger than the original brightness of the main pixel 110, the driving brightness of the sub pixel 120 is smaller than the original brightness of the sub pixel 120, and the mixed gamma response of the main pixel 110 and the sub pixel 120 is equivalent to the preset gamma response; A data line 200 is electrically connected to the main sub-pixel 111 and the sub-sub-pixel 121 with the same driving polarity in two adjacent sub-pixel columns, and a main sub-pixel 111 is electrically connected to only one data line 200 and a sub-sub-pixel 121 is electrically connected to only one data line 200.

This application also provides a display device, which includes a display panel and a driving unit, the driving unit is electrically connected with the data line, the driving unit is arranged to output a driving signal to the data line, and the driving unit is also electrically connected with the scanning line of the display panel, and the specific structure of the display panel is referred to the above embodiment and will not be described in detail here.

The above is only the preferred embodiment of the present application and is not therefore limiting the scope of the patent of the present application. The equivalent structure or equivalent process changes made in the application specification and drawings, or directly or indirectly applied in other related technical fields, are similarly included in the patent protection scope of this application.

What is claimed is:

1. A display panel, wherein the display panel comprises:
a plurality of pixel groups, wherein each of the pixel groups comprises a main pixel and a sub pixel, the main pixel comprises a main sub-pixel, the sub pixel comprises a sub-sub-pixel, the main sub-pixel and the sub-sub-pixel are arranged in a rectangular array, and the main sub-pixel and the sub-sub-pixel located in a same column form a sub-pixel column; and
a plurality of data lines, extending in a longitudinal direction, the data lines being arranged in a transverse direction, and the data lines and the sub-pixel columns being arranged alternately in the transverse direction;
wherein a driving brightness of the main pixel is larger than an original brightness of the main pixel, and a driving brightness of the sub pixel is smaller than an original brightness of the sub pixel; and
one data line is electrically connected with a main sub-pixel and a sub-sub-pixel with a same driving polarity located in two adjacent sub-pixel columns, one main sub-pixel is electrically connected with only one of the data lines, and one sub-sub-pixel is electrically connected with only one of the data lines.

2. The display panel of claim 1, wherein the display panel further comprises:
a plurality of scanning lines, extending in the transverse direction and arranged in the longitudinal direction;
in a same main pixel, the main sub-pixels are longitudinally arranged and electrically connected with a same data line, and the main sub-pixels are electrically connected with different scanning lines respectively; and
in a same sub pixel, the sub-sub-pixels are longitudinally arranged and electrically connected with a same data line, and the sub-sub-pixels are electrically connected with different scanning lines respectively.

3. The display panel of claim 2, wherein a main sub-pixel and a sub-sub-pixel adjacent to the main sub-pixel are electrically connected to different data lines respectively.

4. The display panel of claim 1, wherein the display panel further comprises:
a plurality of scanning lines, extending in the transverse direction and arranged in the longitudinal direction;
in a same main pixel, the main sub-pixels are transversely arranged and electrically connected with a same scanning line, and the main sub-pixels are electrically connected with different data lines respectively; and
in a same sub pixel, the sub-sub-pixels are transversely arranged and electrically connected with a same scanning line, and the sub-sub-pixels are electrically connected with different data lines respectively.

5. The display panel of claim 4, wherein in adjacent pixel groups, driving polarities of the main sub-pixels or the sub-sub-pixels at corresponding positions are opposite.

6. The display panel of claim 1, wherein a mixed gamma response of a main pixel and a sub pixel is equivalent to a preset gamma response.

7. The display panel of claim 6, wherein the display panel further comprises:
a plurality of scanning lines, extending in the transverse direction and arranged in the longitudinal direction;
in a same main pixel, the main sub-pixels are longitudinally arranged and electrically connected with a same data line, and the main sub-pixels are electrically connected with different scanning lines respectively; and
in a same sub pixel, the sub-sub-pixels are longitudinally arranged and electrically connected with a same data line, and the sub-sub-pixels are electrically connected with different scanning lines respectively.

8. The display panel of claim 7, wherein a main sub-pixel and a sub-sub-pixel adjacent to the main sub-pixel are electrically connected to different data lines respectively.

9. The display panel of claim 6, wherein the display panel further comprises:
a plurality of scanning lines, extending in the transverse direction and arranged in the longitudinal direction;
in a same main pixel, the main sub-pixels are transversely arranged and electrically connected with a same scanning line, and the main sub-pixels are electrically connected with different data lines respectively; and
in a same sub pixel, the sub-sub-pixels are transversely arranged and electrically connected with a same scanning line, and the sub-sub-pixels are electrically connected with different data lines respectively.

10. The display panel of claim 9, wherein in adjacent pixel groups, driving polarities of the main sub-pixels or the sub-sub-pixels at corresponding positions are opposite respectively.

11. The display panel of claim 1, wherein the main pixels and the sub pixels are arranged crosswise.

12. The display panel of claim 11, wherein the display panel further comprises:
a plurality of scanning lines, extending in the transverse direction and arranged in the longitudinal direction;
in a same main pixel, the main sub-pixels are longitudinally arranged and electrically connected with a same data line, and the main sub-pixels are electrically connected with different scanning lines respectively; and
in a same sub pixel, the sub-sub-pixels are longitudinally arranged and electrically connected with a same data line, and the sub-sub-pixels are electrically connected with different scanning lines respectively.

13. The display panel of claim 12, wherein a main sub-pixel and a sub-sub-pixel adjacent to the main sub-pixel are electrically connected to different data lines respectively.

14. The display panel of claim 11, wherein the display panel further comprises:
a plurality of scanning lines, extending in the transverse direction and arranged in the longitudinal direction;
in a same main pixel, the main sub-pixels are transversely arranged and electrically connected with a same scanning line, and the main sub-pixels are electrically connected with different data lines respectively; and
in a same sub pixel, the sub-sub-pixels are transversely arranged and electrically connected with a same scanning line, and the sub-sub-pixels are electrically connected with different data lines respectively.

15. The display panel of claim 14, wherein in adjacent pixel groups, driving polarities of the main sub-pixels or the sub-sub-pixels at corresponding positions are opposite.

16. The display panel of claim 1, wherein a driving polarity of a driving signal on a data line is periodically inverted.

17. A display panel, wherein the display panel comprises:
a plurality of pixel groups, wherein each of the pixel groups comprises a main pixel and a sub pixel, the main pixel and the sub pixel are arranged crosswise, the main pixel comprises a main sub-pixel, the sub pixel comprises a sub-sub-pixel, the main sub-pixel and the sub-sub-pixel are arranged in a rectangular array, and the main sub-pixel and the sub-sub-pixel located in a same column form a sub-pixel column, and the main sub-pixel and the sub-sub-pixel located in a same row form a sub-pixel row;
a plurality of data lines, extending in a longitudinal direction, the data lines being arranged in a transverse direction, and the data lines and the sub-pixel columns being arranged alternately in the transverse direction;
a plurality of scanning lines, extending in the transverse direction and arranged in the longitudinal direction, and the scanning lines and the sub-pixel rows are arranged alternately in the longitudinal direction;
wherein a driving brightness of the main pixel is larger than an original brightness of the main pixel, a driving brightness of the sub pixel is smaller than an original brightness of the sub pixel, and a mixed gamma response of a main pixel and a sub pixel is equivalent to a preset gamma response; and
one data line is electrically connected with a main sub-pixel and a sub-sub-pixel with a same driving polarity located in two adjacent sub-pixel columns, one main sub-pixel is electrically connected with only one of the data lines, and one sub-sub-pixel is electrically connected with only one of the data lines.

18. A display device, wherein the display device comprises:
a display panel, wherein the display panel comprises: a plurality of pixel groups, wherein the pixel group comprises a main pixel and a sub pixel, the main pixel comprises a main sub-pixel, the sub pixel comprises a sub-sub-pixel, the main sub-pixel and the sub-sub-pixel are arranged in a rectangular array, and the main sub-pixel and the sub-sub-pixel located in the same column form a sub-pixel column;
a plurality of data lines, extending in a longitudinal direction, the data lines being arranged in a transverse direction, and the data lines and the sub-pixel columns being arranged alternately in the transverse direction; wherein a driving brightness of the main pixel is larger than an original brightness of the main pixel, and a driving brightness of the sub pixel is smaller than an original brightness of the sub pixel; and
one data line is electrically connected with a main sub-pixel and a sub-sub-pixel with a same driving polarity located in two adjacent sub-pixel columns, one main sub-pixel is electrically connected with only one of the data lines, and one sub-sub-pixel is electrically connected with only one of the data lines.
a driving unit, wherein the driving unit is electrically connected with the data line, the driving unit is configured to output a driving signal to the data line, and the driving unit is also electrically connected to the scanning line of the display panel.

19. The display device of claim 18, wherein a mixed gamma response of a main pixel and a sub pixel is equivalent to a preset gamma response.

20. The display device of claim 18, wherein a driving polarity of a driving signal on the data lines is periodically inverted.
